(19) United States
(12) Patent Application Publication
(10) Pub. No.: US 2006/0182911 A1
(43) Pub. Date: Aug. 17, 2006

(54) Gas barrier pet composition for monolayer bottle and process thereof

(76) Inventors: Kulkarni Sanjay Tammaji, Tamil Nadu (IN); Bisht Harish, Tamil Nadu (IN); Lakshminarayanapuram Ramaswami Subbaraman, Tamil Nadu (IN)

Correspondence Address: HEDMAN & COSTIGAN P.C., 1185 AVENUE OF THE AMERICAS, NEW YORK, NY, 10036, US

(21) Appl. No.: 11/252,339

(22) Filed: Oct. 17, 2005

Related U.S. Application Data
(60) Provisional application No. 60/619,665, filed on Oct. 19, 2004.

(51) Int. Cl. B32B 27/08

(52) U.S. Cl. 428/35.7

(57) ABSTRACT

Novel alloy/blends barrier resins consisting of a composition of Polyethylene Terephthalate (PET) and Polytrimethylene Naphthalate (PTN) or PET and Polybutylene Naphthalate (PBN) exclusively for packaging beverages like beer in a monolayer bottle outperforming the existing other barrier multi-layer bottles is described. The alloy/blends of PET/PTN and PET/PBN are produced by using in situ polymerization or melt blending the two polymers or compounding the two polymers to get the PTN and PBN in a PET polymer matrix. The composition of PET alloy/blends with PTN and PBN additionally contains other barrier improving additives. Incorporating a suitable oxygen scavenger in these new alloy/blends and converting to a stretch blow molded bottle, with or without heat setting, allows this monolayer bottle to be tunnel pasteurized for protecting beverages like beer filled at specific gas pressure to its maximum shelf life of >180 days keeping under control both oxygen ingress and carbon dioxide egress. The recyclability of used bottles into bottles, fibres and strappings has been established.

### FIELD OF THE INVENTION

The present invention relates to resins suitable for use in the manufacture of bottles and containers for filling beverages such as beer and methods for making the resin and methods of making bottles using the resin.

This invention also relates a resin and a process for making resins having suitable oxygen scavenging properties and gas barrier properties.

The resins formed in accordance with this invention contain suitable gas barrier agents and oxygen scavengers such that the stretch blow molded monolayer bottles made out of these alloy/blend resins have adequate CO₂ and O₂ barrier properties and are capable of withstanding tunnel pasteurization of beverages like beer.

### BACKGROUND OF THE INVENTION

One of the fastest growing trends in the food packaging industry is the conversion from conventional glass and metal packaging materials to ones made of plastic. There are many advantages in using plastic materials such as reductions in weight and cost, but the barrier properties of these materials are invariably different from the conventional packaging systems, thus impacting the shelf stability of the product. A major concern for many products, and particularly for beverages like beer, is oxidation degradation by oxygen ingress causing taste changes and darkening of the beer, flattening of taste by carbon dioxide loss and damage due to UV light. Over the planned shelf life of a bottle about 1 ppm oxygen maximum ingress into the bottle is acceptable. The egress of carbon dioxide from the beverage through the bottle walls also has to be attenuated to a minimum. For successful conversion from glass to plastic it is very essential to consider oxygen, carbon dioxide, water vapor and flavor scalping as they affect the quality of the products particularly when stored over extended periods of time.

The prevailing mono layer PET bottle isn't equivalent to a glass bottle in either carbonation retention or oxygen barrier properties. While glass offers a shelf life of minimum 6 months, the 33-g PET bottle is coded for seven weeks. Consequently, distribution channels have to be carefully selected. Supermarkets, for instance, may not receive these bottles. But liquor stores, convenience stores, and the hotel and restaurant trade may accept these beverages packed in PET bottles as beverages from such outlets are typically consumed shortly after they're purchased. The main advantage of these bottles is that they are shatter resistant.

PET resins are widely used in the food packaging industry, in such products as bottles and films. PET bottles are used for the carbonated soft drink, fruit juice and mineral water. These products have a shelf life of 8-12 weeks and over this period the gas permeability properties of PET are considered sufficient. However, alcoholic beverages like beer are much more sensitive to oxygen and carbon dioxide diffusion either into or out of the bottle. When this sensitivity to migrating gases is combined with the need for a longer shelf life, it is necessary to improve on the gas permeability properties of PET.

Converting beer from glass to PET is a daunting challenge, requiring a barrier against carbon dioxide egress and oxygen ingress, protection from UV light, while also retaining clarity and thermal stability for withstanding tunnel pasteurization at 60° C. for 20 to 30 minutes apart from recyclability of the bottles back into the usage stream as per conventional technology. To overcome gas ingress-egress, the bottle industry manufacturers who wish to convert to synthetic polymer bottles have several options:

[a] Various techniques are used to remove oxygen from the product. These include removing the oxygen under vacuum, sparging the product with an inert gas and packaging the product in an inert atmosphere. These techniques may eliminate head space oxygen but do not address the problem of permeation of oxygen permeating through the bottle walls into the bottle cavity and into the product.

[b] Another technique is to build CO2 and O2 barrier into PET bottles by designing a multi-layer structure sandwiching PET structural layers around a core layer or layers containing higher-priced barrier materials. This approach stands to benefit from promising new barrier materials such as nylon-based nano composites and “passive-active” barrier systems. The latter are dual-acting formulations of a passive barrier material and an active oxygen scavenger that blocks O₂ entry and also absorbs O₂ from the head space and contents. A number of new barrier materials favors proliferation of multi-layer PET containers. Materials like MXD6 nylon and ethylene vinyl alcohol (EVOH) are well known. Multilayered bottles have been tried out, in which apart from PET one of the layers is a resin such as ethylene vinyl alcohol [EVOH] or Poly vinyl diethylene chloride [PVDC] which exhibit passive resistance to oxygen. As is clear, in this method thin layers of barrier polymers that have low gas permeability, are sandwiched in the center of a bottle wall encapsulated by PET on either side.

U.S. Pat. No. 6,787,094 discloses a method for making a multilayer injection molded plastic articles in successive mold cavities. In a first molding step, an inner sleeve is molded on a core in a first mold cavity, which may comprise a full body length sleeve or only a partial sleeve, such as an upper neck finish portion. The sleeve and core are withdrawn from the first mold cavity while the sleeve is still warm, and transferred without substantial delay to a second mold cavity for injection molding an outer layer which bonds to the inner sleeve. By transferring the sleeve at an elevated temperature into the second mold cavity, an improved bond is formed between the inner sleeve and outer layer which resists separation during a later reheat stretch blow molding step, and/or in use of the resulting article. In a preferred embodiment, a pasteurizable beer container is provided having a finish-only sleeve of a PEN polymer.

Again, Patent application no WO 9702939 discloses Sleeve molding apparatus and methods for making multilayer injection molded plastic articles in successive mold cavities. In a first molding step, an inner sleeve is molded on a core in a first mold cavity, which may comprise a full body length sleeve or only a partial sleeve, such as an upper neck finish portion. An improved bond is formed between the inner sleeve and outer layer which resists separation during a later reheat stretch blow molding step, and/or in use of the resulting article. In a preferred embodiment, a pasteurizable beer container is provided having a finish only sleeve of a PEN polymer.

Although, advances in multi-layer and surface-coating technologies are diminishing the cost advantage of glass bottles and metal cans for beer, carbonated soft drinks (CSDs), oxygen-sensitive juices, and hot-filled foods and new barrier resins and oxygen scavengers, lower-cost surface coatings, and higher-output multi-layer PET preform molding systems are on continuous development, delamination with time, incapacity for tunnel pasteurizability at 60° C. for 20-30 minutes and serious constraints in recyclability through conventional streams remain as serious limitations; and moreover such multilayered bottles are difficult and relatively more and expensive to make too.

Surface-coating technologies apply a super-thin barrier to one surface of a mono layer PET bottle. Several available barrier-coating technologies are differentiated by the type of coating material, coating placement (interior or exterior), and application method. These coatings lower the overall ingress of gas into the beverage. These techniques use materials such as graphite, silica, and epoxy resins to achieve the effect. This technique again involves additional steps in the bottle forming process and is therefore more expensive. These also suffer from incapacity to withstand tunnel pasteurizability at 60° C. for 20-30 minutes and recyclability through conventional recycling streams.

The “ideal” route to a barrier PET bottle is a mono layer polyester structure. This approach usually employs a PET polymer or alloy/blend as the base resin; the oxygen scavenger resin is blended with the base resin and the preform is produced in the injection molding machine. The bottles are then blown either by normal Stretch Blow Molding or Heat Set Stretch Blow Molding. This indeed eliminates delamination problems and some capital costs associated with co-injection. However the major obstacle is that 80% of the world's beverages like beer require tunnel pasteurization for retention of taste and flavor. This puts beverages like beer into the bottle at temperatures that expose it to thermal stress and gas pressures that typically cause such PET mono layer bottles to fail.

To redress this problem various methods have been tried out:

[a] Oriented PET barrier bottles have emerged recently among blow molders and food-packaging companies. Patent WO 9813266A1 discloses a transparent oxygen-scavenging article for packaging oxygen-sensitive products, such as beer, juice, ketchup, etc. The bottle includes a biaxially-oriented aromatic polyester polymer such as polyethylene terephthalate (PET) or polyethylene naphthalate (PEN), and an oxygen-scavenging aromatic ester polymer compatible with the polyester polymer.

[b] Thus bottles can be made from non PET polyesters with lower gas permeability, such as polyethylene naphthalate (PEN). PEN, a cousin of PET, typically has potential to deliver a five-fold improvement in both CO2 and O₂ barrier versus mono layer PET, along with higher heat resistance and good clarity. PEN has a Tg of ˜120° C., far exceeding that for PET, so PEN polymers have potential to deliver mono layer bottles to withstand tunnel pasteurization but there are difficulties in stretch blow molding these bottles and the technology has achieved limited success due to erratic behaviour and haze in injection molding with conventional technology. Further difficulties are encountered in bottle blowing of PEN polymer or its alloy/blends with PET. On the whole, PEN containers are also cost prohibitive for single serve application.

[c] Mono layer PET bottles based on PET blended or compounded with Naphthalates and Isophthalates, such as terpolymer or TIN polymer, have also been attempted with no significant success.

Pasteurization is an alternative to sterile filtration for reducing the number of harmful microorganisms in beer. The basis for pasteurization is the heating of the beer for a predetermined period of time at specific temperatures, thereby assuring the microbiological stability of the beer. A Pasteurization Unit (PU) is defined as a one-minute exposure to a temperature of 60° C. A PU is a measure of the lethal effect on microorganisms of the heat treatment. The aim is to attain the minimum degree of pasteurization necessary to inactivate beer-spoiling organisms. The two main types of pasteurization techniques are flash and tunnel. Flash pasteurization is used for continuous treatment of bulk beer prior to filling the bottles, cans, or kegs. It is typically carried out in a plate heat-exchanger before transferring the beer to the beer tank. Tunnel pasteurization is used mainly for in-pack treatment following the crowning or closing of the bottles. Flash pasteurization is not widely used by breweries in North America (though it is very popular with the dairy and juice industries), but it has been widely adopted in Europe and Asia. In flash pasteurization, the beer is heated to at least 71.5 to 74° C. and held at this temperature between 15 and 30 seconds. Flash pasteurization of beer typically uses a two- or three-stage plate heat exchanger with hot water as the heat exchange medium.

An alternative to flash pasteurization and sterile filtration is tunnel pasteurization. Tunnel pasteurization is employed after bottles have been filled, pressurized with CO₂ to about 35 psi or ˜4.0 Gas Volume (GV) and sealed. The bottles are loaded at one end of the pasteurizer and passed under sprays of water as they move along the conveyor. The sprays are so arranged that the bottles are subjected to increasingly hot water spray until the pasteurization temperature (usually 60° C.) is reached by the beer in the bottles. The bottles are then gradually cooled with water until they are discharged from the end of the pasteurizer. Temperature changes have to be made in stages to prevent the bottles from breaking, if not reduce the incidence of the same. Passage through the tunnel pasteurizer takes about an hour, comprising about 15-20 minutes for heating up the product to 60° C. plus, about 20 minutes for maintaining the product at 60° C. and about 15-20 minutes for cooling the product to room temperature.

U.S. Pat. No. 6,863,988 discloses a Oxygen scavenging monolayer bottles comprised of an oxygen scavenging composition suitable for direct contact with package contents and recycle with other polyester bottles. The oxygen scavenging composition includes PET and PEN. These monolayer bottles are pasteurizable under limited conditions but their use has serious limitations due to significant problem in injection-molding and stretch blow-molding processes. This is primarily due to the significant differential in glass transition temperature Tg and melting point Tm apart from the differences in crystallinity rates for PET and PEN.

Again WO9824844A1 discloses a process for making a controlling the change of intrinsic viscosity and transesterification during solid stating of a polyethylene terephthalate (PET) and polyethylene naphthalate (PEN) blend, with an effective amount of an alkylene glycol compound. The process enables the production of a copolymer based on predefined initial and final IV's and final transesterification level, by varying the solid-stating time and/or effective amount of alkylene glycol. It has been stated that the resin formed can be used for making monolayer bottles. However there is no evidence of commercialization presumably due to the same constraints like U.S. Pat. No. 6,863,988 above.

WO Patent 9511801A1 discloses an improved oxygen barrier and oxygen absorbing compositions and structures comprising blends of xylylene group-containing polyamides and cobalt octoate and xylylene group-containing polyamides, polyesters and cobalt octoate. These blends have barrier properties and clarity obtained by controlling the degree of orientation and the amount of cobalt. These novel blends are used as single layers and as the core layer in multiple layer structures, the adjacent layers are comprised of polyesters and/or polyamides. Each layer in the multiple layer structures can optionally be bonded together by the use of an adhesive or tie layer. These are however not tunnel pasteurizable nor recyclable by conventional means.

There is therefore a need for a resin composition which can be used for making a monolayer bottle for beverages by conventional stretch blow molding processes and which has gas barrier properties and at same time can withstand tunnel pasteurization at the required temperature and CO₂ pressure and which will meet the criterion of recyclability.

### STATEMENT OF THE INVENTION

According to this invention there is provided a resin for the manufacture of monolayer container for beverages comprising an alloy/blend of polyethylene terephthalate resin [PET] together with at least one napthalate based resin selected from a group of napthalates consisting of Polytrimethylene napthalate and Polybutylene napthalate, [PTN/PBN] in a ratio of PET: PTN/PBN ranging between 99:1 to 75:25. In accordance with one embodiment of the invention, the said resin being made by in situ polymerization. According to another the said resin is made by melt blending. According to yet another, the said resin is made by extrusion.

In accordance with a preferred embodiment of the invention, the resin includes therein at least one additive selected from a group of additives consisting of oxygen scavenging agents, nucleating agents, barrier improving agents, toners, and color improving agents. In a particular embodiment the naphthalate component of the resin ranges from PTN/PBN from 99:1 to 75:25.

The scope of the invention extends to a preform for a container for beverages made from the resin as well as to a container for beverages made from a resin.

There is also provided a process for producing a molded product comprising the steps of: melt-kneading polyethylene terephthalate resin [PET] and at least one napthalate based resin selected from a group of napthalates consisting of Polytrimethylene napthalate and Polybutylene napthalate, [PTN/PBN] in a ratio of PET: PTN/PBN ranging between 99:1 to 75:25 under injection molding conditions comprising a molding temperature of 275 to 325.degree. C., a residence time of 80 to 230 sec, a plasticizing time of 5 to 40 sec and a shear rate of 50 to 200 sec.sup.-1 to form a preform; and blow-molding the preform under blow-molding conditions comprising a molding temperature of 80 to 160.degree. C., a blow pressure of 25 to 40 kgf/cm.sup.2 and a mold contact time of 5 to 20 sec.

Alternatively, the process includes the step of adding at least one additive selected from a group of additives consisting of oxygen scavenging agents, nucleating agents, barrier improving agents, toners, and color improving agents and the naphthalate component of the resin ranges from PTN/PBN from 99:1 to 75:25.

In accordance with another embodiment of the invention, the process comprises the steps of adding at least one naphthalate based resin selected from a group of naphthalates consisting of Polytrimethylene naphthalate and Polybutylene naphthalate, [PTN/PBN] in the process of polymerizing [PET] resin, said naphthalate being added during melt polymerization of PET resin, such that the ratio of PET resin eventually formed: PTN/PBN ranges between 99:1 to 75:25.

In accordance with another embodiment of the invention, the process includes the steps of adding at least one naphthalate based resin selected from a group of naphthalates consisting of Polytrimethylene naphthalate and Polybutylene naphthalate, [PTN/PBN] in the process of polymerizing [PET] resin, said naphthalate being added during solid state polymerization of PET resin, such that the ratio of PET resin eventually formed: PTN/PBN ranges between 99:1 to 75:25.

Alternatively, the process includes the steps of adding the ingredients for making at least one naphthalate based resin selected from a group of naphthalates consisting of Polytrimethylene naphthalate and Polybutylene naphthalate, [PTN/PBN] in the process of polymerizing [PET] resin, said naphthalate being added at least during one of the stages of formation of the PET resin, such that the ratio of PET resin eventually formed: PTN/PBN ranges between 99:1 to 75:25.

In this invention therefore there is developed alloy/blends of PET with PTN or PBN and incorporated the advantages of the polymers viz. PET, PTT and Naphthalate based resins in these alloy blends.

The alloy/blends are produced either by (i) by physical blending of the corresponding homo polymers in the appropriate proportion or (ii) addition of the second monomer or its components to the PET reactor in the beginning along with the PET raw materials viz. PTA and MEG, or adding them at the end of esterification or addition towards the end PET polymerization and thereby prepare the alloy/blend by an in-situ polymerization or (iii) by melt blending PET and the second polymer in a single or twin screw extruder. PTN having a relatively low melting point and melt viscosity is ideally suited to make this alloy/blended resin as it easily gets mixed and well dispersed in the polymer melt. These alloy/blended resins are suitable for conversion to a mono layer bottle which is superior to the existing alternatives viz. multi layer versions and mono layer with TIN based polymers in respect of morphological characteristics like crystallinity, mechanical and thermal properties and are capable of withstanding tunnel pasteurization.

These alloy/blend resin bottles can be made by SBM with or without heat setting based on judicious design of the bottles as per the need of the applications.

Therefore, the present invention relates to a gas barrier resin composition comprising PET along with one or more materials selected from naphthalate based polymers such as Polytrimethylene Naphthalate and Polybutylene Naphthalate

This invention also relates a process of making alloy/blends of PET with PTN, or PBN or combination thereof having suitable oxygen scavenging properties and gas barrier properties. This high barrier resins contain suitable oxygen scavengers such that the stretch blow molded mono layer bottles made out of these alloy/blend resins having adequate CO₂ and O₂ barrier properties are capable of withstanding tunnel pasteurization of beverages like beer. The present invention also relates to a process for preparing containers for packing beverages like beer, carbonated beverages, aerated drinks and other similar materials. Also, the product of the present invention may be used as a film in packing of food applications.

The main object of the invention is to provide alloy/blends of two or more polymers which can have excellent gas barrier characteristic and can withstand the temperature treatment during tunnel pasteurization.

A feature of the invention is to provide alloy/blends of PET and PTN or PBN or combinations thereof by an in situ polymerization or melt blending the polymers or compounding the polymers in an extruder.

Another feature of the invention is to provide alloy/blends of PET and PTN or PBN having a composition of PET: PTN/PBN to maximum of 75:25 by an in situ polymerization or melt blending the two polymers or compounding the two polymers in a single screw or twin screw extruder to get the PTN/PBN in a PET polymer matrix.

Yet another feature of the present invention is to provide the polyester PET which is used for making the alloy/blend with PTN/PBN to have suitable additives like non antimony catalysts, nucleating agents, barrier improvement chemicals, and color improving compounds of cobalt and suitable toners.

Still another feature of the present invention is to provide an alloy/blend of PET and PTN/PBN and incorporate the advantages of the properties in PET and Naphthalate based resins particularly their barrier properties to oxygen and carbon dioxide.

Yet another feature of the invention is to use the alloy/blend of PET and PTN/PBN to make the preforms by injection molding and convert them to mono layer bottles by stretch blow molding and make them suitable for sensitive packaging of beverages like beer.

Another feature of the present invention is to have screw or crown type caps for the mono layer bottles which are suitable for the specific application viz. beverages like beer wherein the caps are capable of withstanding tunnel pasteurization it prevents oxygen ingress or carbon dioxide egress through the cap i.e. without being affected by the type of closure.

One more feature of the present invention is to incorporate suitable oxygen scavengers in the PET-PTN/PBN alloy/blends to act as an active oxygen barrier and prevent oxygen ingress into the mono layer beer bottle.

It is also envisaged within the scope of this present invention to incorporate suitable pigment/dye additives in the PET-PTN/PBN alloy/blends to impart colorations like amber, green, blue etc. as per the requirement of the package and confirm that they are compatible with the alloy/blend base.

Still another feature of the present invention is to make use of the alloy/blends of PET-PTN/PBN resin for trouble free injection molding and stretch blow molding to bottles without any processing problems while converting to bottles as experienced with other mono layer bottles with TIN based resins.

Yet another feature of the present invention is to develop the PET-PTN/PBN alloy/blends suitable for ISBM to mono layer bottles specifically for beer applications which will withstand tunnel pasteurization.

Last but not least, perfect recyclability through conventional methods with existing streams of recycling of bottle to bottle and into fibres/strappings is a significant feature of this invention.

### DESCRIPTION OF THE INVENTION

The PET used for making the alloy/blend containing the heavy metal free catalyst, additives like nucleating agents, barrier improvers, heat stabilizers and color improving agents has the following properties as given in Table-I for the amorphous and solid state polymerized resins as an example and which does not limit the scope of this application.

TABLE 1
Properties of Amorphous and SSP PET

| | | PET | |
|---|---|---|---|
| | | AMORPHOUS | PET SSP |
| Sl. No. | PARAMETER | RESIN | RESIN |
| 1. | Intrinsic Viscosity, dl/g | 0.64 + 0.02 | 0.82 + 0.05 |
| 2. | COOH No., meq/kg | 35 + 5.0 | 32 + 5.0 |
| 3. | DEG, wt. % | Maximum 1.0 | Maximu 1.0 |
| 4. | L* | Minimum 70 | Minimum 75 |
| 5. | a* | −1.0 + 0.3 | −1.0 + 0.2 |
| 6. | b* | −5.0 + 1.0 | −3.0 + 1.0 |
| 7. | Tg, ° C. | 80 + 2 | 80 + 2 |
| 8. | Tm, ° C. | 250 + 2 | 250 + 2 |

Note:
L*, a*, b* Color values are measured in crystallized unground sample

Prior Art on PTN:

PTN as a substance is known as early as 1969. Good Year Tyre & Rubber Co. has mentioned about PTN in U.S. Pat. No. 3,446,778. Around the same period E I DuPont has also referred PTN and its application in helically crimpable composite staple fibers in their patent GB1165312. Shell Chemicals in one of their presentations in 1998 on “PTN and Copolymers: New Opportunities in Film and Packaging Applications” has compared the properties of PET, PTT, Nylon 6 and PTN.

None of these earlier works have mentioned anything about the manufacturing process of PTN. The first recorded information on the procedure of making the copolyester of PTT containing 9 mole % of PTN by making use of PDO and NDC is available in Eastman Chemical Company's U.S. Pat. No. 5,989,665 of 1999. Between 2000 and 2004 Tejin has a series of Japanese patents (e.g. JP2000102976, JP2000017064 etc.) mainly on applications of PTN for film usage. Tejin Limited's U.S. Pat. No. 6,525,165 of Feb. 25, 2005 gives in their Example the procedure for making PTN from NDC and PDO and the barrier properties of PTN film. A similar mention of making PTN is made in Teijin's U.S. Pat. No. 6,740,402 of May 25, 2004 for its application in polyester fibre. E I Du Pont's US Patent Application 20040043169 of Mar. 4, 2004 also gives a procedure for making PTN from NDC and PDO for multi layer film application. Their U.S. Pat. No. 6,531,548 of Mar. 11, 2003 on Blends of PTN and U.S. Pat. No. 6,749,785 of Jun. 15, 2004 on Multi layer Structures of PTN also describe the same procedure of making PTN. Pfizer Health AB in their U.S. Pat. No. 6,790,496 of Sep. 14, 2004 has used PTN for its application for packing nicotine containing products.

PTN Synthesis

The PTN used as the passive barrier additive in this invention can be manufactured by the procedures adopted in U.S. Pat. Nos. 6,749,785; 6,531,548; 6,740,402 and US Application 20040043169 or in accordance with the following procedure:

9.35 kg of Dimethyl 2,6-naphalenedicarboxylate (NDC)(from BP Amoco) and 4.15 kg of 1,3-propanediol (PDO)(from Shell chemicals) were reacted under atm. pressure in presence of Manganese acetate (40 ppm as Mn) along with Cobalt acetate (40 ppm as Co) which basically acts as a colorant.

All these raw materials/additives are charged to the reaction vessel and ester interchange is conducted. First drop of Methanol experienced at 190° C., Reactor heated to 230° C. in 150 minutes and 90% of the byproduct (MeOH) is evolved. Balance MeOH along with excess 1,3-Propanediol is distilled by reducing the reaction pressure from atm. to 500 mbar in 20 minutes. During this period, mass temperature was increased to 245° C.

Nitrogen is used to break vacuum in the reaction vessel and 50 ppm of Phosphorous based heat stabilizer compound is charged to the reactor to deactivate the trans esterification catalyst.

Polymerization was carried out in presence of 200 ppm Tin catalyst viz.oxides of tin, acetates of tin or Butyl Stannic Acid which was charged to the reaction vessel just before commencing polymerization. Pressure in the reaction vessel was reduced to 50 mbar from 1050 mbar in 50 minutes, then the mass temperature was increased to 260° C. from 245 in 70 minutes. During this period, pressure in the reaction vessel reduces to 1 mbar. Polymerization was terminated at the fixed set KW of the agitator to attain the desired Intrinsic Viscosity.

The amorphous PTN polymer thus obtained was transparent, clear, semicrystalline material and its properties are given Table-II. The SSP PTN resin used for making the alloy/blend of PET/PTN has the following properties (Refer Table-II), given as a typical example of alloy/blended resin.

TABLE II
Properties of Amorphous and SSP PTN Resin

| | | PTN | |
|---|---|---|---|
| | | AMORPHOUS | PTN SSP |
| No. | PARAMETER | RESIN | RESIN |
| 1. | Intrinsic Viscosity, | 0.5 ± 0.05 | 0.75 ± 0.05 |
| | dl/g | | |
| 2. | COOH No., meq/kg | 20 ± 5 | 10 ± 3 |
| 3. | L* | 75 ± 3 | 80 ± 3 |
| 4. | a* | −1.3 ± 0.3 | −1.0 ± 0.3 |
| 5. | b* | −3.0 ± 0.2 | −1.8 ± 0.2 |
| 6. | Tg, ° C. | 78 ± 2 | 78 ± 2 |
| 7. | Tm, ° C. | 202 ± 2 | 202 ± 2 |

Note:
L*, a*, b* Color values are measured in crystallized unground sample

Prior Art on PBN

There are not many references fro the manufacture, preparation and application of PBN. Japanese Patent (JP) 6107921 deals with the melt stability of PBN. JP6172626 describes a PBN resin with improved impact resistance by blending polyester-ether elastomer. JP7138461 describes a PEN/PBN composition with excellent heat resistance, moldability and mechanical properties. SSP of PBN to improve heat stability, hydrolysis resistance and hue are dealt with in JP2000159866 which also mentions the synthesis of PBN using a Ti containing composite catalyst. JP2003214564 deals with the application of PBN for fuel hose consisting of an inner layer of PBN elastomer which is claimed to be superior in low permeability to fuel for an automobile. U.S. Pat. No. 6,294,234 compares PBN which has a higher bending strength and flexibility and a lower tensile strength and impact strength with another thermoplastic material used as a conduit for fuel or fuel vapor. U.S. Pat. No. 5,663,238 deals with a random copolyester of PEN and PBN and gives details of its synthesis.

PBN Synthesis:

In this invention PBN is produced by reacting 10 kg of NDC with 5.5 kg of BDO in presence of Butyl Tin catalyst (2.5 g) added in two stages before and after esterification. Esterification was carried out at a max. temperature of 195° C. and the polycondensation at a max temperature of 254° C. to get the required I.V. of the amorphous PBN which was subjected to SSP to increase the I.V. for alloying with PET. Properties of the amorphous and SSP PBN resin are given in Table-III.

TABLE III
Properties of Amorphous and SSP PBN Resin

| | | PBN | |
|---|---|---|---|
| | | AMORPHOUS | PBN SSP |
| No. | PARAMETER | RESIN | RESIN |
| 1. | Intrinsic Viscosity, | 0.6 ± 0.02 | 0.83 ± 0.03 |
| | dl/g | | |
| 2. | COOH No., meq/kg | 15 ± 3 | 10 ± 3 |
| 3. | L* | 82 ± 3 | 82 ± 3 |
| 4. | a* | −1.3 ± 0.3 | −1.0 ± 0.3 |
| 5. | b* | −2.0 ± 0.2 | −0.8 ± 0.2 |
| 6. | Tg, ° C. | 80 ± 2 | 80 ± 2 |
| 7. | Tm, ° C. | 240 ± 2 | 240 ± 2 |

The above three resins of PET, PTN or PBN are blended in the proportion of PET: PTN/PBN ranging between 99:1 and 50:50 and compounded in a twin screw extruder. While compounding additives like oxygen scavenger (quantity ranging between 500 and 3000 ppm) and the appropriate pigment for coloration viz. amber, green etc. are also added.

Alternatively instead of separately making the PTN or PBN the required amounts of 1,3-Propane Diol (PDO) or 1,4-Butane Diol (BDO) and 2,6-Naphthalene Dicarboxylate (NDC) are added along with the PET raw materials viz. PTA and MEG in the reactor or the PDO/BDO and NDC are added at the end of the esterification of PTA and MEG or they are added towards the end of PET polymerization such that the in-situ polymerization of PDO/BDO and NDC takes place and gets alloy/blended in the PET system giving the required PET-PTN/PBN blend.

The properties of the compounded alloy/blends of PET-PTN/PBN containing the oxygen scavenger and the colored pigments are given Table-IV.

Examples of Preparation of PET-PTN or PET-PBN or PET-PTN-PBN Alloy (8% as a Typical Case)

### EXAMPLE 1

Co Extrusion: 92 kg PET resin and 8 kg of PTN are thoroughly mixed, dried and processed through an extruder. The zone temperatures of the extruder are maintained

[symbol]

### EXAMPLE 7

Raw material blending: PET-PTN Alloy was formed by taking 7.7 kg PTA, 0.75 kg NDC, 3.37 kg MEG and 0.33 kg PDO in an esterification reactor. In addition to the antimony catalyst (2.5 g) 4 ppm of Mn.Acetate, 4 ppm of Cobalt Acetate and 20 ppm of Butyl Tin were added as additional catalysts. The esterification and poly condensation are carried out by the normal procedure and PET-PTN alloy was taken out as chips. These chips were converted into bottles as per example 1.

### EXAMPLE 8

Raw material blending: The same reactants were mixed in a paste of PTA and charged to the esterificatrion reactor. The esterification and poly condensation was carried out as per example 7 and by the normal procedure and PET-PTN alloy granules were taken out and converted to bottles as per example 1.

### EXAMPLE 9

Raw material blending: PET-PBN Alloy: 7.65 kg of PTA, 0.80 kg NDC, 3.26 kg MEG and 0.4 kg BDO were taken in the esterification reactor. In addition to the antimony catalyst (2.5 g) 0.2 g of Butyl Tin was added as additional catalysts. The esterification and poly condensation was carried out as per example 7 and by the normal procedure and PET-PBN alloy granules were taken out and converted to bottles as per example 1.

### EXAMPLE 10

Raw Material Blending:

PET-PTN-PBN Alloy: 7.7 kg of PTA, 0.77 kg of NDC, 3.3 kg of MEG, 0.17 kg PDO and 0.2 kg of BDO were taken in the esterification reactor. In addition to the antimony catalyst (2.5 g) 0.2 g of Butyl Tin are added as additional catalysts. The esterification and poly condensation was carried out as per example 7 and by the normal procedure and PET-PTN-PBN alloy granules were taken out and converted to bottles as per example 1.

### EXAMPLE 11

The same reactants of Example 10 were mixed in a paste of PTA and charged to the esterificatrion reactor. The esterification and poly condensation was carried out as per example 7 and by the normal procedure and PET-PBN-PTN alloy granules were taken out and converted to bottles as per example 1.

In all the above examples the PET prepared is a homopolyester. Depending on the need, a maximum of 2% Isophthalic Acid (IPA) is added while making the PET to prepare the copolyester of PET-IPA.

Preparation of the PET Alloy of PTN,PBN and PTN-PBN with Barrier and Oxygen Scaveger Additive.

While preparing the PET or the PET-PTN, PET-PBN and the PET-PTN-PBN alloys the barrier and OS are incorporated in the resin in the following manner as an example.

### EXAMPLES 12 to 15

78 kg PTA, 34 kg MEG were taken in the esterification reactor [could be made into a paste and added into the esterifier.] 7.5 g of Sodium Acetate, 1.35 g of Sodium Benzoate, 0.022 kg of Nyacol (Nano Silica), 2 g of Sodium Salicylate are added as barrier additives. 1 g of the clear fast reheat additive is also added together with 8.48 g of Cobalt Acetate, 1.5 ppm each of the Red and Blue toners were added improve the color of the polymer. Towards the end of polymerization in different batches [1] 8 kg of PTN, [2] 8 kg of PBN and [3] a mixture of 4 kg each of PTN & PBN were added to the melt and the mixed melt was kept under agitation for an additional period of 15 minutes. The molten PET-PTN alloy resin, PET-PBN alloy resin and PET-PTN-PBN alloy resin with the barrier additives are taken out as a strand, cooled and cut into granules.

Alternatively, the Oxygen Scavenger could be added as a master batch to the alloy during the bottle making or the Oxygen Scavenger as such is added as a powder in the extruder along with alloy chips before making the bottles.

The bottles were molded under injection molding conditions which include a molding temperature of 275 to 325.degree. C., a residence time of 80 to 230 sec, a plasticizing time of 5 to 40 sec and a shear rate of 50 to 200 sec.sup.-1 to form a preform; and blow-molding the preform under blow-molding conditions comprising a molding temperature of 80 to 160.degree. C., a blow pressure of 25 to 40 kgf/cm.sup.2 and a mold contact time of 5 to 20 sec.

TABLE IV
Properties of PET-PTN & PET-PBN Alloys made in accordance
with the afore said examples

| | | ALLOY | ALLOY |
|---|---|---|---|
| Sl. No. | PARAMETER | PET/PTN | PET/PBN |
| 1. | Intrinsic Viscosity, | 0.88 ± 0.02 | 0.82 ± 0.02 |
| | dl/g | | |
| 2. | Tg, ° C. | 80 ± 2 | 81 ± 2 |
| 3. | Tm, ° C. | 248 ± 2 | 252 ± 2 |
| 4. | % Crystallinity | 33 ± 3 | 36 ± 3 |

The compounded alloy blend resins of PET-PTN/PBN is dried to a moisture level of <0.005% and injection molded into performs. The preforms are converted to 330 ml, 500 ml and 650 ml bottles by ISBM method both by normal and heat setting procedures.

The oxygen and carbon dioxide permeation through a particular set of these bottles are checked and the results are given in Table-V along with a comparison with PET, PEN, PTN and PBN resin.

TABLE V
Comparison of the Barrier Properties of PET/PTN bottles
Vs. Bottles of PET, PEN, PTN and PBN

| | Permeation or | | | | | | |
|---|---|---|---|---|---|---|---|
| | Gas | | | | | | |
| | Transmission, | | | | | | |
| | cc. mil/ | | | | | | |
| | 100 in² · atm. | | | | | PET/ | PEN/ |
| Sl. No. | day at 35° C. | PET | PEN | PTN | PBN | PTN | PBN |
| 1. | Oxygen | 12 | 6 | 3 | 2 | 4 | 3 |
| 2. | Carbon | 65 | 17 | 10 | 9 | 15 | 13 |
| | Dioxide | | | | | | |

It can be seen from the above data that the PET/PTN/PBN alloy/blend with active oxygen scavenger has excellent barrier properties against oxygen and carbon dioxide which are detrimental for beer.

Table-VI gives the details of Carbon Dioxide (CO₂) retention and Oxygen (O₂) ingress in PET/PTN/PBN alloy/blended empty bottles of different sizes. The CO₂ permeation is measured by GMS equipment supplied by Applied Films, Germany which gives the barrier improvement factor (BIF) with respect to a reference as well as the permeation of CO₂ with respect to time. The O₂ ingress was measured by Orbisphere oxygen analyzing equipment. For comparison data for a normal carbonated soft drink (CSD) bottle is also given.

TABLE VI
CO₂ and O₂ Permeation in PET/PTN (92:8)
Alloy/Blended Bottles under Ambient Conditions

| | | | | ppm gain of | |
|---|---|---|---|---|---|
| Serial | Bottle | Bottle | % Loss in | O₂ in one | |
| No. | Weight, g | Volume, ml | CO₂/week | month | Remarks |
| 1 | 28 | 500 | 2.19 | 4.00 | Normal |
| | | | | | CSD |
| 2 | 24 | 330 | 2.10 | 0.75 | PET/PTN |
| 3 | 28 | 500 | 1.75 | 0.60 | PET/PTN |
| 4 | 33 | 650 | 1.52 | 0.55 | PET/PTN |

% CO2 Loss—If % loss is taken as 100 for CSD bottle then the PET/PTN alloy/blended bottles for Serial Nos. 2, 3 &4 will be % 96, 80 & 69 showing the barrier effectiveness of the alloy/blend bottle. Stating in another way the CO2 barrier property of the alloy/blended bottles of Serial Nos. 2, 3 & 4 are x1.04, x1.25 & x1.44 times better than the CSD bottle. In terms of loss in CO2 pressure with time the general allowed universal value is 17.5% loss as the limit. Based on this value CSD bottle will hold good for 8 weeks whereas Serial Nos. 2, 3 & 4 will hold good for 9, 10 & 11.5 weeks.
ppm O2 gain—If % gain is taken as 100 for CSD bottle then the PET/PTN alloy/blended bottles for Serial Nos. 2, 3 & 4 will be 19, 15 & 14 showing the combined active and passive O₂ barrier effectiveness of the alloy/blend bottle. Stating in another way the O₂ barrier property of the alloy/blended bottles of Serial Nos. 2, 3 & 4 are x5.26, x6.66 & x7.14 times better than the CSD bottle.
The CO2 pressure is determined with a Gas Volume Tester (Zahn Nagel) provided with a Piercing Device. The bottles are filled to 50 psi with CO2 and allowed to equilibrate for 24 hours so that the dissolved CO2 and the head space CO2 attains equlibrium.
Similar experiments were carried out using PET/PBN alloy/blend having a PBN composition of 8% in PET. The results are similar to the one given above except that PET/PBN gave ˜5% improvement in CO2 egress and O₂ ingress indicating PET-PBN alloy is marginally superior to PET-PTN alloy.

A laboratory set up was made to simulate the tunnel pasteurization conditions wherein the filled and CO2 pressurized bottles are subjected to 63° C. for 20 minutes after the contents reach 63° C. The bottles are then taken out and kept in an ambient temperature water bath for 45 minutes. The bottles are then examined for any deformation or shape change and also for any leaks from the cap. The carbonation loss if any is checked using Gas Volume Tester with a Piercing Device.

Test results of Tunnel Pasteurization of the beer bottles filled with water and carbonated are given in Table-VII Different bottle sizes with 28 PCO and crown caps were tested and the bottle characteristics before and after pasteurization were compared.

TABLE VII
Tunnel Pasteurization of PET/PTN Alloy/Blended Bottles filled with
Carbonated Water
TABLE - VII PET-PTN ALLOY BARRIER RESIN WITH OXYGEN
SCAVENGER

| | Bottle | | | | | | | |
|---|---|---|---|---|---|---|---|---|
| Volume | Wt. | Neck | Bottle | Pr. | Temp. | | Bottle | |
| (ml) | (g) | Finish | No. | (Psi) | ° C. | G.V. | Shape | Remarks |
| 650 | 30 | 28 | 1 | 50 | 25 | 3.2 | * | Before |
| | | PCO | 2 | 47 | 26 | 3.0 | * | Pasteurization |
| | | | 3 | 48 | 25 | 3.5 | OK | After |
| | | | | | | | | Pasteurization |
| | | | 4 | 50 | 28 | 3.2 | OK | |
| | | | 5 | Kept for Visual | | | OK | |
| | | | | Inspection | | | | |
| 650 | 30 | CROWN | 1 | 48 | 25 | 3.2 | * | Before Pasteurization |
| | | | 2 | 46 | 25 | 3.4 | * | |
| | | | 3 | 50 | 25 | 3.5 | OK | After Pasteurization |
| | | | 4 | 47 | 25 | 3.0 | OK | |
| | | | 5 | Kept for Visual | | | OK | |
| | | | | Inspection | | | | |
| 500 | 28 | 28 | 1 | 46 | 25 | 3.8 | * | Before Pasteurization |
| | | PCO | 2 | 48 | 25 | 3.2 | * | |
| | | | 3 | 45 | 26 | 3.0 | OK | After Pasteurization |
| | | | 4 | 40 | 25 | 2.9 | OK | |
| | | | 5 | | | | | |
| 500 | 28 | CROWN | 1 | 42 | 26 | 5 | * | Before Pasteurization |
| | | | 2 | 44 | 25 | 4.7 | * | |
| | | | 3 | 40 | 25 | 2.8 | OK | After Pasteurization |
| | | | 4 | 38 | 25 | 2.7 | OK | |
| | | | 5 | Kept for Visual | | | OK | |
| | | | | Inspection | | | | |
| 330 | 24 | 28 | 1 | 50 | 26 | 4.9 | * | Before |
| | | PCO | 2 | 47 | 27 | 5.3 | * | Pasteurization |
| | | | 3 | 50 | 27 | 2.9 | OK | After |
| | | | 4 | 48 | 27 | 3.3 | OK | Pasteurization |
| | | | 5 | Kept for Visual | | | OK | |
| | | | | Inspection | | | | |
| 330 | 24 | CROWN | 1 | 47 | 26 | 5 | * | Before |
| | | | 2 | 45 | 25 | 4.7 | * | Pasteurization |
| | | | 3 | 40 | 26 | 3.0 | OK | After |
| | | | 4 | 45 | 26 | 2.9 | OK | Pasteurization |
| | | | 5 | Kept for Visual | | | OK | |
| | | | | Inspection | | | | |
| 650 | 34 | CROWN | 1 | 37 | 12 | * | * | Before |
| | | | 2 | 40 | 25 | * | * | Pasteurization |
| | | | 3 | 42 | 27 | 3.70 | OK | After |
| | | | 4 | 54 | 27 | 6.60 | OK | Pasteurization |
| | | | 5 | 42 | 27 | 5.80 | OK | |

Procedure Adopted:
Bottles are blown in house
Bottles are filled with water and carbonated in house
No distortion or rocking of bottles observed
Final dimensions of bottles found to be OK

When the experiments are repeated with PET/PBN instead of PET/PTN the pasteurization results are almost similar to that obtained with PET/PTN alloy.

These results indicate that the PET/PTN/PBN alloy/blend mono layer bottles with 285PCO or crown cap are able to withstand tunnel pasteurization and suitable for beer application.

Test results of Tunnel Pasteurization of the PET/PTN alloy/blend beer bottles filled with carbonated beer in two different breweries are given in Table-VIII A & B. Different bottle sizes with 28 PCO and crown caps were tested and the bottle characteristics before and after pasteurization were compared.

TABLE VIII A
Tunnel Pasteurization of PET/PTN Alloy/Blended Bottles filled
with Beer in the Brewery
TABLE VIII A BEER BOTTLE WITH OS - TEST RESULTS - BREWERY 1

| | Bottle | | | | | | | |
|---|---|---|---|---|---|---|---|---|
| | Wt. | Neck | Bottle | Pr. | Temp. | | Bottle | |
| Volume (ml) | (g) | Finish | No. | (PSI) | ° C. | G.V. | Shape | Remarks |
| 650 | 30 | 28 | 1 | 48 | 25 | 3 | * | Before |
| | | PCO | 2 | 46 | 26 | 3.1 | * | Pasteurization |
| | | | 3 | 50 | 26 | 3.2 | OK | After |
| | | | 4 | 50 | 26 | 3.2 | OK | Pasteurization |
| | | | 5 | Kept for Visual | | | OK | |
| | | | | Inspection | | | | |
| 650 | 30 | CROWN | 1 | 43 | 25 | 2.9 | * | Before |
| | | | 2 | 49 | 25 | 3.2 | * | Pasteurization |
| | | | 3 | 50 | 25 | 3.3 | OK | After |
| | | | 4 | 40 | 25 | 2.8 | OK | Pasteurization |
| | | | 5 | Kept for Visual | | | OK | |
| | | | | Inspection | | | | |
| 500 | 28 | 28 | 1 | 45 | 25 | 3 | * | Before |
| | | PCO | | | | | | Pasteurization |
| | | | 2 | 40 | 25 | 2.7 | * | After |
| | | | 3 | 42 | 26 | 2.8 | OK | Pasteurization |
| | | | 4 | 40 | 26 | 2.8 | OK | |
| | | | 5 | Kept for Visual | | | OK | |
| | | | | Inspection | | | | |
| 500 | 28 | CROWN | 1 | 40 | 25 | 2.9 | * | Before |
| | | | 2 | 37 | 26 | 2.8 | * | Pasteurization |
| | | | 3 | 38 | 24 | 2.8 | OK | After |
| | | | 4 | 36 | 24 | 2.7 | OK | Pasteurization |
| | | | 5 | Kept for Visual | | | OK | |
| | | | | Inspection | | | | |
| 330 | 24 | 28 | 1 | 50 | 25 | 3.3 | * | Before |
| | | PCO | | | | | | Pasteurization |
| | | | 2 | 49 | 25 | 3.2 | * | After |
| | | | 3 | 53 | 27 | 3.3 | OK | Pasteurization |
| | | | 4 | 44 | 27 | 2.9 | OK | |
| | | | 5 | Kept for Visual | | | OK | |
| | | | | Inspection | | | | |
| 330 | 24 | CROWN | 1 | 48 | 26 | 3 | * | Before |
| | | | 2 | 45 | 25 | 2.9 | * | Pasteurization |
| | | | 3 | 43 | 26 | 2.8 | OK | After |
| | | | 4 | 40 | 26 | 2.5 | OK | Pasteurization |

| | | |
|---|---|---|
| 5 | Kept for Visual | OK |
| | Inspection | |

Procedure Adopted:
Bottles were blown in house
Bottles carbonated in Brewery-1 followed by Tunnel Pasteurization using spray chamber at 63° C. Water temperature ramped from ambient of 28° C. to 63° C. in 12 minutes and temperature maintained at 63° C. for 20 minutes and then cooled to ambient temperature in 45 minutes.
The pasteurized bottles were tested in house
Final dimensions of the bottles were taken and found OK

No distortion or rocking of the bottles were observed

TABLE VIII B
Tunnel Pasteurization of PET/PTN or PET/PBN Alloy/Blended
Bottles filled with Beer in the Brewery
TABLE VIII B BEER BOTTLE WITH OS - TEST RESULTS - BREWERY 2

| | Bottle | | | | | | | |
|---|---|---|---|---|---|---|---|---|
| | Wt. | Neck | Bottle | Pr. | Temp. | | Bottle | |
| Volume ml | (g) | Finish | No. | (PSI) | ° C. | G.V. | Shape | Remarks |
| 500 | 28 | 28 | 1 | 28 | 10 | 3.4 | * | Before |
| | | PCO | 2 | 36 | 25 | 2.6 | * | Pasteurization |
| | | | 3 | 34 | 28 | 2.3 | OK | After |
| | | | 4 | 44 | 28 | 2.8 | OK | Pasteurization |
| | | | 5 | 37 | 28 | 2.5 | OK | |
| 650 | 34 | CROWN | 1 | 35 | 10 | 3.9 | * | Before |
| | | | 2 | 41 | 25 | 2.9 | * | Pasteurization |
| | | | 3 | 40 | 27 | 2.6 | OK | After |
| | | | 4 | 51 | 27 | 3.2 | OK | Pasteurization |
| | | | 5 | 43 | 27 | 2.8 | OK | |
| 330 | 24 | CROWN | 1 | 32 | 10 | 3.7 | * | Before |
| | | | 2 | 42 | 26 | 2.8 | * | Pasteurization |
| | | | 3 | 44 | 33 | 2.4 | OK | After |
| | | | 4 | 40 | 33 | 2.3 | OK | Pasteurization |
| | | | 5 | 42 | 33 | 2.4 | OK | |

Procedure Adopted:
Bottles blown in house
Bottles filled with carbonated beer in Brewery 2
Tunnel Pasteurization done in Brewery 2
Pasteurized bottles tested in house
Final dimensions of the bottles checked and found OK
No distortion or rocking of the bottles observed
The filled pasteurized beer bottles were also tested for the routine tests like top load, drop tests, stress cracking test, burst test and bottle weight distribution and found OK.

The head space oxygen ingress in filled pasteurized 500 ml beer bottles with crown cap after 90 days duration was found to be 0.55 ppm. The same test with a 28 PCO cap with an OS liner gave a value of 0.62 ppm. Though both the test have shown oxygen ingress well within the norms the crown cap exhibits a marginal advantage.

Similar test after 90 days with these filled bottles for CO₂ retention and egress showed a drop in pressure of 8% with respect to the initial value. The loss in CO₂ pressure is again within the norms.

The UV/Amber barrier data of the PET/PTN and PET/PBN alloy/blended bottle having a 13 mil panel are given in Table-IX

TABLE IX
UV Barrier Data of PET-PTN or PET-PBN Alloy/Blended Bottles

| Serial | Bottle | | Cut off |
|---|---|---|---|
| No. | Composition | % Transmission | Wavelength, nm |
| 1. | PET | <10 | 320 |
| 2. | PET + 8% PTN or | <10 | 370 |
| | 8% PBN Alloy/ | | |
| | Blend | | |
| 3. | PET + 8% PTN or | <10 | 550 |
| | 8% PBN Alloy/ | | |
| | Blend with 0.2% | | |
| | Amber Color | | |

Recyclability of BeerPET Resins Comprising an Alloy/Blend of PET with PTN/PBN.
Used amber colored BeerPET bottles are converted to pellets and processed through pilot plant spinning and drawing machinery to produce black fibre. The results are compared with those obtained with 100% virgin PET-PTN/PBN alloy resin and the fibre properties are the same and not significantly different.
Pellets obtained from used amber colored BeerPET bottles are blended at 10% level with 90% virgin PET-PTN/PBN alloy resin and the blended resin converted to bottles by ISBM. These bottles showed similar properties as obtained from 100% virgin alloy resin and also withstood tunnel pasteurization.

1. A resin for the manufacture of monolayer container for beverages comprising an alloy/blend of polyethylene terephthalate resin [PET] together with at least one napthalate based resin selected from a group of napthalates consisting of Polytrimethylene napthalate and Polybutylene napthalate, [PTN/PBN] in a ratio of PET: PTN/PBN ranging between 99:1 to 75:25.

2. A resin for the manufacture of monolayer container for beverages as claimed in claim 1, the said resin being made by in situ polymerization.

3. A resin for the manufacture of monolayer container for beverages, the said resin is made by melt blending.

4. A resin for the manufacture of monolayer container for beverages as claimed in claim 1, the said resin is made by extrusion.

5. A resin for the manufacture of monolayer container for beverages as claimed in claim 1, including therein at least one additive selected from a group of additives consisting of oxygen scavenging agents, nucleating agents, barrier improving agents, toners, and color improving agents.

6. A resin for the manufacture of monolayer container for beverages as claimed in claim 1, in which the naphthalate component of the resin ranges from PTN/PBN from 99:1 to 75:25.

7. A preform for a container for beverages made from a resin as claimed in claim 1.

8. A container for beverages made from a resin as claimed in claim 1.

9. (canceled)

10. A molded product of the resin composition of claim 1.

11. The molded product of claim 10 which is a preform.

12. The molded product of claim 10 which is a bottle.

13. A process for producing a molded product comprising the steps of: melt-kneading polyethylene terephthalate resin [PET] and at least one napthalate based resin selected from a group of napthalates consisting of Polytrimethylene napthalate and Polybutylene napthalate, [PTN/PBN] in a ratio of PET: PTN/PBN ranging between 99:1 to 75:25 under injection molding conditions comprising a molding temperature of 275 to 325.degree. C., a residence time of 80 to 230 sec, a plasticating time of 5 to 40 sec and a shear rate of 50 to 200 sec.sup.-1 to form a preform; and blow-molding the preform under blow-molding conditions comprising a molding temperature of 80 to 160.degree. C., a blow pressure of 25 to 40 kgf/cm.sup.2 and a mold contact time of 5 to 20 sec.

14. A process as claimed in claim 13, in which the process includes the step of adding at least one additive selected from a group of additives consisting of oxygen scavenging agents, nucleating agents, barrier improving agents, toners, and color improving agents.

15. A process as claimed in claim 13, in which the naphthalate component of the resin ranges from PTN/PBN from 99:1 to 75:25.

16. A process for producing a molded product comprising the steps of adding at least one naphthalate based resin selected from a group of naphthalates consisting of Polytrimethylene naphthalate and Polybutylene naphthalate, [PTN/PBN] in the process of polymerizing [PET] resin, said naphthalate being added during melt polymerization of PET resin, such that the ratio of PET resin eventually formed: PTN/PBN ranges between 99:1 to 75:25.

17. A process for producing a molded product comprising the steps of adding at least one napthalate based resin selected from a group of naphthalates consisting of Polytrimethylene napthalate and Polybutylene napthalate, [PTN/PBN] in the process of polymerizing [PET] resin, said naphthalate being added during injection molding of preforms, such that the ratio of PET resin eventually formed: PTN/PBN ranges between 99:1 to 75:25.

18. A process for producing a molded product comprising the steps of adding the ingredients for making at least one napthalate based resin selected from a group of napthalates consisting of Polytrimethylene napthalate and Polybutylene napthalate, [PTN/PBN] in the process of polymerizing [PET] resin, said naphthalate being added at least during one of the stages of formation of the PET resin, such that the ratio of PET resin eventually formed: PTN/PBN ranges between 99:1 to 75:25.

19. A process for producing a molded product comprising the steps of adding predetermined quantities of a diol selected from 1,3-Propane Diol (PDO) and 1,4-Butane Diol (BDO) and 2,6-Naphthalene Dicarboxylate (NDC) in the process of polymerizing [PET] resin, said naphthalate being added at least during one of the stages of formation of the PET resin, such that the ratio of PET resin eventually formed: PTN/PBN ranges between 99:1 to 75:25.

20. The used amber colored beer bottles made out of the PET-PTN/PBN alloy is recylable by conventional methods to 100% recycled black fiber/strappings and as a 10% mix with 90% virgin alloy resin to bottles again for reuse in beer application.
